(19) United States
(12) Patent Application Publication
(10) Pub. No.: US 2011/0175744 A1
(43) Pub. Date: Jul. 21, 2011

(54) Systems and Method for the Mobile Evaluation of Cushioning Properties of Shoes

(76) Inventors: Walter Englert, Burgrieden (DE); Oliver Braun, Karlsbad (DE); Thorsten Habel, Walzbachtal (DE); Martin Gierich, Stutensee (DE); Florian Hoeflinger, Muenchen (DE); Mirko Janetzke, Muenchen (DE); Christian Holzer, Muenchen (DE)

(21) Appl. No.: 12/996,599

(22) PCT Filed: May 18, 2009
(86) PCT No.: PCT/EP2009/003524

§ 371 Date: Feb. 25, 2011

(30) Foreign Application Priority Data
Jun. 6, 2008 (DE) 10 2008 027 104.7

(51) Int. Cl. G08B 21/00; A43B 23/24; A43C 9/00; A43B 5/00; A43B 23/02; G01L 5/00; G06F 19/00; G06F 15/00

(52) U.S. Cl. 340/665; 36/137; 36/136; 36/134; 36/45; 73/862.381; 702/41; 702/141

(57) ABSTRACT

Shoe having at least one pressure sensor provided in the shoe cushioning element, as well as system components for emitting, receiving and evaluating the signals of the sensor.

The present invention relates to a method and a system for the evaluation of cushioning properties of shoes by means of one or several pressure sensors provided in the shoe cushioning element.

Moreover, the present invention relates to a system for the exact determination of the movement of an athlete by means of an acceleration sensor provided in the shoe cushioning element.

Moreover, the present invention relates to a system for illuminating an area in front of an athlete by means of light-emitting diodes.

Moreover, the present invention relates to a system for tightening the shoelaces by means of an electric motor and a rope winch which are provided in the shoe cushioning element.

Moreover, the present invention relates to a system for a shooting reinforcement in soccer shoes.

Sports shoes are particularly subjected to loads and, depending on their nature, essentially contribute to health and success during sportive activities. Here, it is important that when shoes are bought, optimal ones are selected, and that they are replaced early enough when the cushioning properties diminish.

The selection of sports shoes is usually supported by an analysis of the running movement. For this, the roll behavior and the supporting properties of the shoe are observed and analyzed. Furthermore, the shoe is selected taking into consideration the body weight and the application to be expected to ensure that the shoe is suited for the load to be expected.

This analysis is often carried out on a treadmill. For this, the treadmill can be equipped, for example, with a video camera and pressure sensors, so that it is possible to determine the suitability of the shoe by slow motion, freeze frame and the measured load distribution.

Since with unpracticed runners who only rarely train on a treadmill, balance plays a decisive role, it can occur, however, that the athlete does not maintain his normal running style. It can occur, for example, that an athlete touches the ground with his forefoot while he normally is a heel striker. Furthermore, running on a treadmill cannot be compared to running outdoors, for example on a farm track, already due to the absolutely plane running surface.

Moreover, after the athlete has bought the shoe, there are only very imprecise indications to identify when a shoe must be replaced due to the diminishing cushioning properties. Usually, this point in time is determined based on the covered distance, where the influence of the runner's weight and the ground on which he runs is neglected.

It is therefore the object of the present invention to permit a precise analysis of the suitability of a shoe under real conditions.

Another object of the present invention is to permit a precise determination of the movement of an athlete.

Another object of the present invention is to illuminate the area in front of the athlete.

Another object of the present invention is to automatically tighten the shoelaces of a shoe.

Another object of the present invention is to stiffen the upper side of the shoe during shooting.

These objects are achieved by the subject matters of the independent claims.

Preferred embodiments are the subject matter of the depending claims.

The inventive application of at least one permanently installed pressure sensor in the shoe cushioning element is based on the finding that it is particularly advantageous to check the above-described properties of shoes, such as for example their cushioning properties, not only when the shoe is being bought, but continuously.

Another advantageous aspect of a preferred embodiment of the present invention is based on the fact that the pressure sensor can be used, apart from for the evaluation of the cushioning property, also for indicating the pressure, the weight of the athlete, a change of the athlete's weight, a pressure frequency or a speed calculated therefrom.

A further advantageous aspect of a preferred embodiment of the present invention is based on the fact that the pressure sensor can be used for controlling light-emitting diodes provided in the shoe such that an area in the running direction is illuminated.

A further advantageous aspect of a preferred embodiment of the present invention is based on the fact that the pressure sensor can be used in combination with a three-dimensional acceleration sensor provided in the shoe for determining the three-dimensional track (trajectory), speed, power or energy of the movement.

A further advantageous aspect of a preferred embodiment of the present invention is based on the fact that the pressure sensor can be used in combination with a rope winch provided in the shoe and an electric motor provided in the shoe for automatically tightening the shoelaces.

A further advantageous aspect of a preferred embodiment of the present invention is based on the fact that the pressure sensor can be used in combination with an insert provided in the shoe's upper which is filled with an electro- or magneto-rheological fluid for controlling a shooting reinforcement.

A further advantageous aspect of a preferred embodiment of the present invention is based on the fact that the pressure sensor can be equipped in combination with several rigid cleats and several cleats that are movably held by means of a nut joint which can be tilted in the direction of inclination of the shoe by electromagnets arranged around the movable cleats and are thus suited for improving the ground grip of the shoe.

In the following, preferred embodiments of the invention are illustrated more in detail with reference to the enclosed drawings. In the drawings:

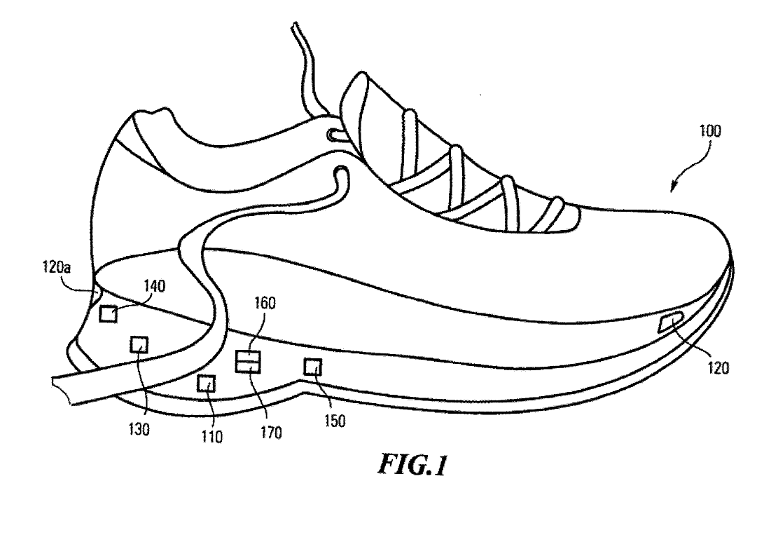

FIG. 1 shows a schematic representation of a shoe with a pressure sensor;

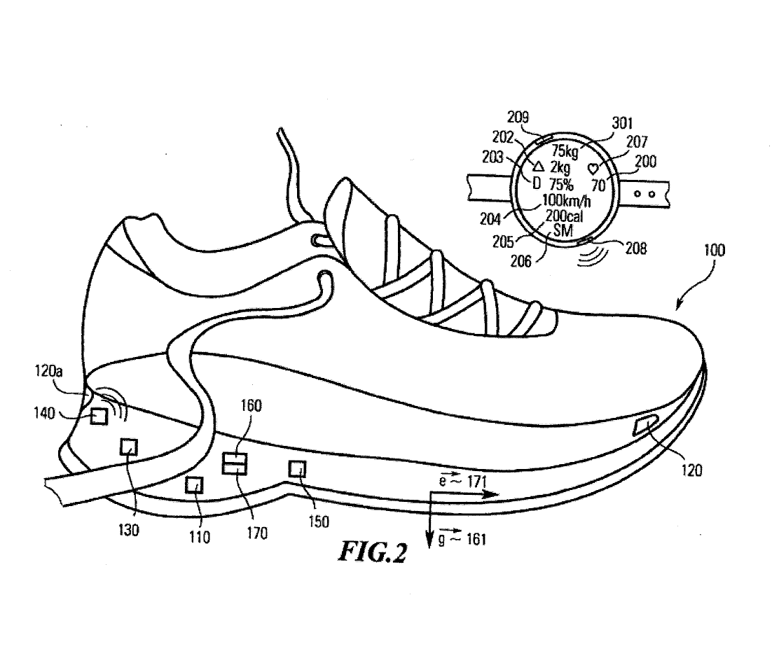

FIG. 2 shows a schematic representation of a shoe and an associated evaluation unit according to a preferred embodiment of the present invention;

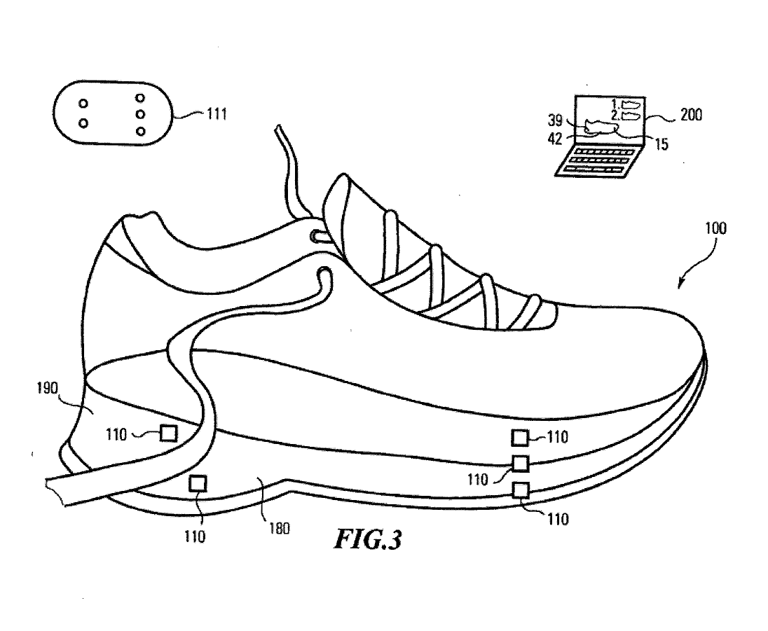

FIG. 3 shows a schematic representation of a shoe and a second evaluation unit according to a preferred embodiment of the present invention;

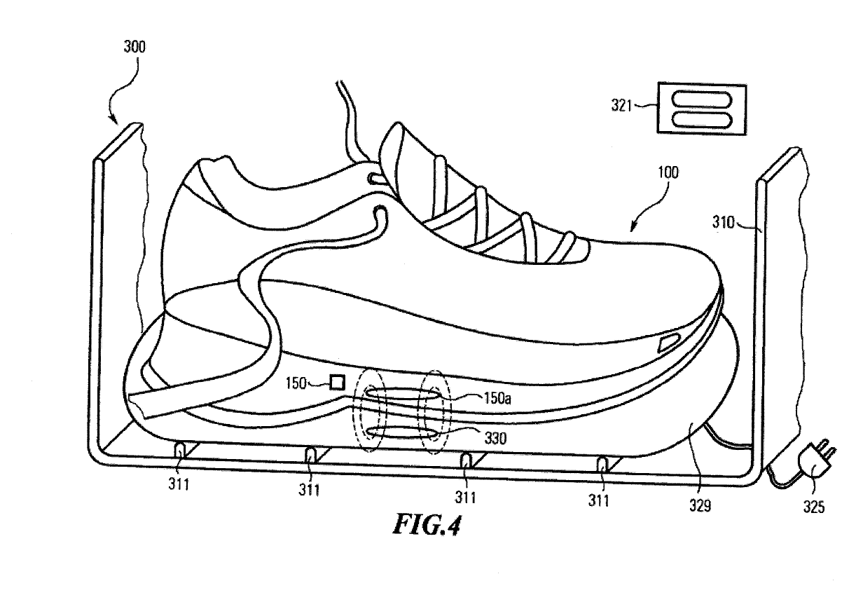

FIG. 4 shows a schematic representation of a shoe with an associated storage container according to a preferred embodiment of the present invention;

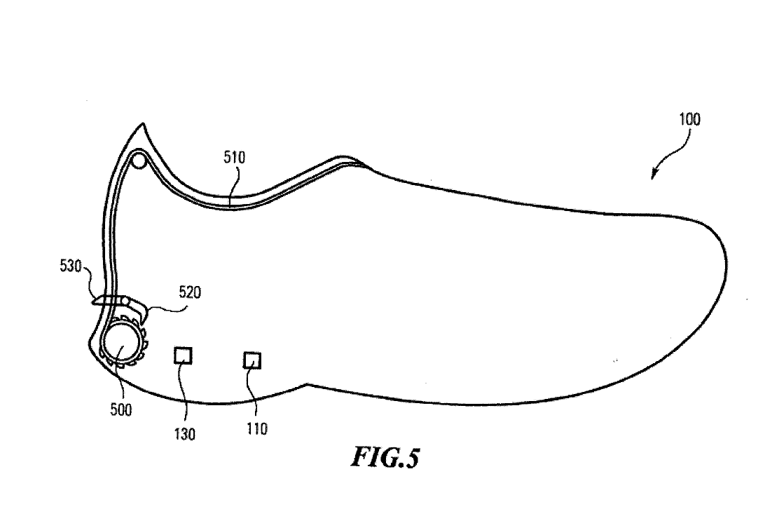

FIG. 5 shows a schematic representation of a shoe with an automatic shoe tying means according to a preferred embodiment of the present invention;

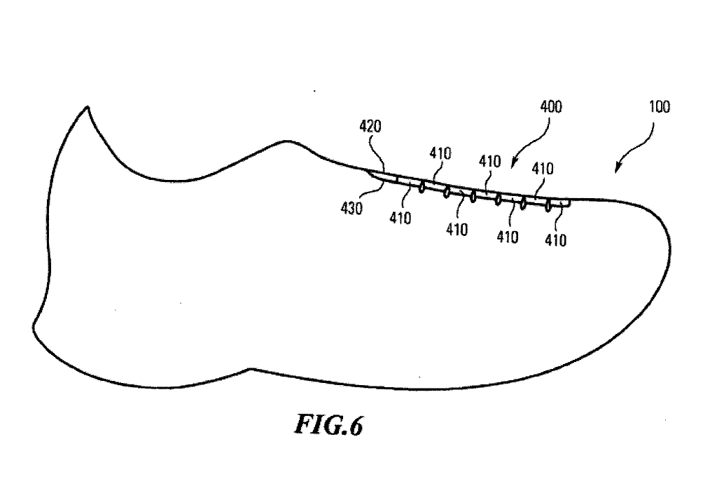

FIG. 6 shows a schematic representation of a shoe with a shooting reinforcement according to a preferred embodiment of the present invention; and

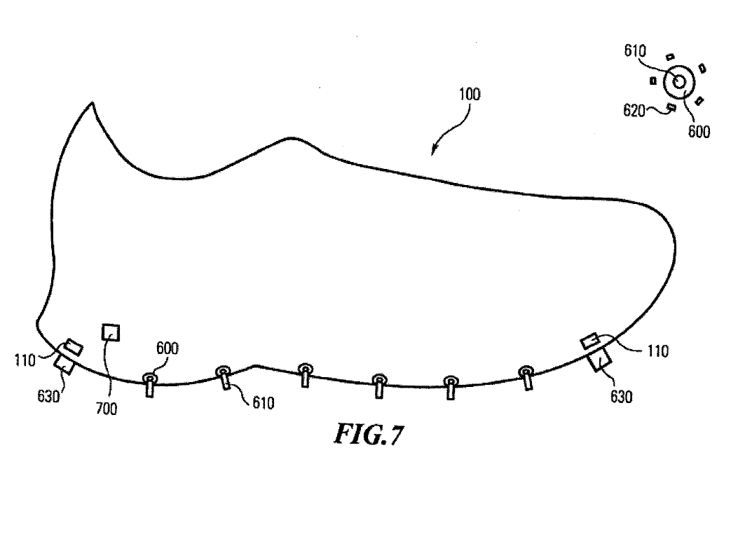

FIG. 7 shows a schematic representation of a shoe with orienting cleats according to a preferred embodiment of the present invention.

FIG. 1 shows an overview of all sensors that a shoe according to preferred embodiments of the present invention can contain. One can see therein a schematic representation of a shoe (100) which can be equipped with one or several pressure sensors (110) installed in the cushioning element, one or several LEDs (120), a control unit (130), a radio transmitter (140), a source of energy (150), a three-dimensional acceleration sensor (160), and a sensor (170) which measures the orientation of the acceleration sensor relative to gravitational acceleration.

Here, all mentioned components can be present together, or they can be present each individually or in any combination.

In a first preferred embodiment, according to FIG. 2, a shoe (100) is equipped with a piezoelectric pressure sensor (110) which is installed in the cushioning element of the shoe.

To obtain optimal measured values, the pressure sensor (110) is attached preferably centrically under the heel.

The electric voltage arising due to the load of the piezoelement can be utilized to emit, for example, a 2.4-GHz band radio signal to an evaluation unit (200) by means of a radio transmitter (140). As an alternative, the required energy can also be supplied by a source of energy (150), such as e.g. a battery or an accumulator chargeable inductively or by kinetic energy.

The data contained in the radio signal can be displayed by the evaluation unit (200) for example in the form of a weight indication (201). For this, the evaluation unit is preferably provided with a display. The representation is preferably based on numbers, but as an alternative, a graphical representation, for example in the form of bars or circle diagrams, is also possible.

Furthermore, the pressure acting on the pressure sensor can be displayed instead of the weight, providing for example a biker with information on his pedaling force, or a sprinter with information on his kick-off power.

The evaluation unit (200) can moreover be able to calculate and display changes of weight (202), which can give a marathon runner, for example, valuable hints about when he should take in liquid. Here, the user of the evaluation unit preferably specifies a weight measurement as starting value which can then be automatically compared to current measured values. The difference is then preferably shown on the display of the evaluation unit.

Furthermore, the received radio signal can be used for determining the cushioning properties of the shoe because the measured pressure peaks increase during the movement as cushioning decreases due to the shortened cushioning path. This is due to the pressure being proportional to the change of acceleration per time. A shorter cushioning path thus leads to a change of acceleration within a shorter time and thereby to increased pressure peaks.

Thus, one can, for example, display in the evaluation unit (200) how much percent of the original cushioning property still exists (203) and whether the remaining cushioning property is sufficient for the ground.

For this, a pressure curve typical of the shoe model is stored, for example in the evaluation unit, the pressure curve representing the load of the shoe while a runner is running with the same weight on a given ground, such as for example on asphalt.

As an alternative, the pressure curve can also be measured in a calibration mode by running on the given ground and stored in the evaluation unit.

If the degree of wear of the shoes, and in particular of the cushioning element, is to be determined, the shoe user runs on a given ground, for example in a test mode of the evaluation unit. The measured maximal pressure peaks are then compared to the maximal pressure peaks of the stored curve, and on this basis, it is for example represented how much percent of the original cushioning potential still exists, or whether the shoes should be replaced.

As an alternative, the measured values of the pressure sensor can be used for displaying, for example on the evaluation unit or by means of LEDs provided in the shoe, whether the shoe is suited for the current ground. This is done, for example, by activating a red LED by the control unit.

Furthermore, the evaluation unit (200) can determine the stepping frequency from the received pressure signals and calculate and display the speed (204) by means of a mean step width entered by the user.

As an alternative, a bike mode can be provided in which the speed can be calculated from the entered transmission ratio.

From the weight measurement in combination with measurements of the stepping frequency, pedaling frequency or also the turn frequency in skiing, the expected calorie consumption (205) can be moreover calculated and displayed.

As a supplement to the pressure sensors (110), a piezoelectric acceleration sensor (160) can be installed in the shoe. As piezoelectric acceleration sensors (161) measure gravitational acceleration (161), in a preferred embodiment, the data of the acceleration sensor (160) are corrected by the influence of gravitational acceleration (161).

The information required for this with respect to the orientation of the acceleration sensor (160) can be supplied, for example, via an earth's magnetic field sensor (170). Here, the direction of the earth's magnetic field (171) is determined, where the data of the acceleration sensor can be corrected by the influence of gravity by means of these information because the direction of the earth's magnetic field is perpendicular to the direction of gravitational acceleration. The corrected acceleration data of a three-dimensional acceleration sensor (160) can then be integrated into the evaluation unit and thus supply a detailed image of the movement.

As an alternative, an acceleration sensor which does not measure gravitational acceleration or supplies data already corrected by gravitational acceleration can also be used. This acceleration sensor can be provided in combination with the pressure sensor, but also without the latter.

The data of an acceleration sensor for example permit to exactly determine the running speed and to represent jump distances (206) or changes of direction on the evaluation unit which can be interesting for sports such as broad jump or high jump. Even the complete three-dimensional track of the movement can be determined. In combination with the weight information, the spent force or energy of the movement can also be determined.

The evaluation unit can moreover be adapted to receive and represent data of other sensors, for example a heart rate sensor (207), and to store these information in a storage element present in the evaluation unit.

The data of the storage element can be subsequently read out via radio, for example 2.4-GHz band, WLAN (208) or USB interfaces (209). The described interfaces can also be used for emitting data to the evaluation unit.

As an alternative or as a supplement to the radio transmission of measured values to the evaluation unit, the information can also be stored in a storage medium in the shoe and read out later via radio, e.g. 2.4 GHz or WLAN.

Another possibility of the inventive use of the data of the above-described sensors is the display by means of several LEDs (120) or acoustic signal transmitters installed in the shoe, which can be controlled, for example, by a control unit (130).

Here, for example LEDs (120) of different colors can be used for representing measured values, such as weight, cushioning properties, and walking speed.

Preferably, a relevant range of values is divided into several, preferably three, sections for this, and one colored LED (120) is assigned to each section and lights up or flashes as long as the measured value is within the corresponding range of values.

In case of the representation of weight or of a display of cushioning properties, this could be illustrated with LEDs (120) in the stoplight colors red, yellow and green, green standing for the original or normal condition, and red requesting the user to drink or to change the shoes or to continue running on another ground.

With respect to a speed display, the color distribution could be such that a slow stepping frequency is represented by a green LED (120), a mean stepping frequency by a yellow LED (120), and a fast stepping frequency by a red LED (120). Of course, any color combination can be employed here.

As an alternative, an individual LED (120) which is only activated by the control unit (130) when a value is exceeded can also be employed. Instead of or in addition to the output by means of an LED (120), a warning signal can also sound if e.g. the cushioning property of the shoes has fallen below a critical value or the ground is too hard for the remaining cushioning potential.

Another use of the LEDs according to the invention (120b) is the illumination of the running track in the direction of movement.

For this, preferably one or several white LEDs (120b) are activated by the control unit at the moment when the shoe is in contact with the ground and thus has a horizontal orientation to the ground. The ground contact can be detected, for example, by a pressure value being exceeded. It is achieved thereby that the LEDs (120b) light when the orientation with respect to the running track is correct.

If rotation rate sensors which can determine the orientation of the shoe are additionally present in the shoe, several LEDs can be oriented such that they radiate into different directions and are only activated by a control unit (130) when the current orientation of the shoe contributes to a beam direction in the direction of movement. This is in particular advantageous in biking as here no orientation of the shoe in parallel to the direction of movement can be detected by the pressure sensor.

As an alternative, it is also conceivable to stabilize the orientation of the LEDs (120b) in the direction of movement by a gyroscope.

A pressure sensor is neither required when rotation rate sensors are used, nor when a gyroscope is used.

The use of LEDs according to the above-described method is also possible in a helmet, for example in a ski helmet, which is equipped with a sensor which also permits to measure the orientation of the helmet, or by stabilization of the orientation of the LEDs by means of a gyroscope.

Furthermore, the shoe described in the present invention can also be a ski shoe.

According to a second embodiment, the shoe (100) can be additionally equipped with further pressure sensors (110). These are according to FIG. 3 preferably provided distributed across the sole (180) in the cushioning element (190).

For example, 5 sensors are distributed such that 2 sensors each are provided under the heel, and 3 sensors under the balls of the feet (111). The sensors provided under the heel are attached at the sides of the sole, and the 3 sensors provided under the balls of the feet are attached such that one sensor is located under the central and the two other sensors under the outer balls of the feet.

The thus available two-dimensional pressure distribution can be represented as load profile at the evaluation unit (200), which is, for example, a laptop.

Such a system is in particular suited for supporting the selection of shoes by running in sports outfitters or else in the open country, for example by analyzing the personal running style by means of the measured data.

For this, it can furthermore be provided to search for shoes in a manufacturer's database stored in the evaluation unit (200) whose cushioning properties correspond best to the load profile of the potential buyer, and to then display this recommendation.

This is in particular advantageous because no treadmill is required for this, and measurement is performed under conditions coming close to real running.

If an inductively chargeable accumulator is provided in the shoe, it is preferably charged by means of inductive coupling of two coils. According to FIG. 4, a shoe (100) is placed into a special shoe charging unit (300). The latter consists of a housing (310) which is open to the top as well as a mat (320) which lies on the bottom of the housing on several transverse supports (311) and into which a coil (330) is installed. The coil (330) generates a magnetic field which couples with the coil (150a) installed in the shoe (100) and thus generates an induction voltage by which an accumulator (150) can be charged.

The coil (150a) provided in the shoe (100) is installed as close as possible to the surface of the shoe's bottom side to permit high coupling.

The mat (320) preferably has approximately the size of the shoes and has a mark (321) for positioning the shoes to permit optimal coupling. The housing (310) preferably consists of plastics which is washable and cushions light impacts and shocks.

The mat (320) is preferably equipped with a power supply (325) so that it can be directly connected to the mains. Furthermore, the mat (320) preferably has a charge indication which indicates the charge of the accumulators. Furthermore, the mat (320) preferably has a controller which controls the charging process to prevent the accumulator from being overcharged.

Although the evaluation unit was mainly in particular described as portable minicomputer or laptop, basically all systems are suited which can receive, process and represent the data of the sensors, such as for example a mobile phone equipped with special software, or a PDA.

According to a third embodiment according to the invention, an electric motor and a rope winch can be provided in the cushioning element of the shoe. According to FIG. 5, the electric motor is coupled to the rope winch (500). The rope winch (500) can then be used for automatically tightening the shoelaces (510) with a certain tension. When the shoes are put on, by a first impulse of the pressure sensor (110) or by pressing a button, a signal is emitted to a control unit (130) which controls the electric motor, whereupon the latter tightens the shoelaces via a rope winch.

Unwinding of the rope winch (500) after the shoelaces have been tightened is preferably avoided by an arrest, for example a locking lever (520). This locking lever (520) can be lifted by pressing on a button (530) laterally attached at the cushioning element, where the electric motor is switched off by the control unit (130) and the tension of the shoelaces is released.

According to a fourth preferred embodiment of the invention, a padding is attached over the instep of the shoe which contains an electro- or magneto-rheological fluid, the viscosity of the fluid being controlled by a control unit according to the signals of a pressure sensor. When there is no pressure load, the electro- or magneto-rheological fluid is here preferably controlled such that maximum viscousness is achieved, for example to support a shot in soccer. If pressure is detected, viscosity can be increased again in order not to hinder the roll-off movement of the foot.

As an alternative to the solution with electro- or magneto-rheological fluids, a purely mechanical alternative can also be provided. According to FIG. 6, preferably several plastic rods (410) are here sewn in between two shoe uppers (420, 430) in such a way that they are designed to be movable in one direction and lock in the other direction.

The principle resembles that of a bamboo mat and is achieved by the rods being connected with the shoe upper (420) on the one side lying very closely to each other, while on the other side they are connected to the shoe upper (430) very loosely, and bending only into one direction is thereby possible. Thereby, they for example support the shooting power of a soccer player, but do not hinder the roll-off movement of the foot.

According to a fifth preferred embodiment of the invention, cleats of a shoe can be automatically tilted when the shoe touches the ground such that they are oriented in the direction of inclination of the shoe. For this, according to FIG. 7, a shoe (100) can be equipped with several cleats (610) which are movably held preferably by means of nut joints (600) and have a ferromagnetic core. The orientation of a cleat (610) in the nut joint (600) can then be preferably accomplished by magnets (620) which can be provided around the nut joint (600).

To control the magnets (620), a control unit (700) can be provided in the cushioning element. This control unit (700) can receive the data of several pressure sensors (110) which are attached at the edge of the shoe (100) in the cushioning element over rigid cleats (630), and activate one or several of said magnets according to the signals received.

By the points in time at which the pressure sensors detect a contact with the ground, it is possible to identify into which direction the shoe is inclined, as the cleat (630) touching the ground first indicates the direction of inclination. The cleats (630) are then tilted into the direction of inclination by means of the magnets (620).

Furthermore, the movable cleats (610) can have a length different to that of the rigid cleats (630).

1. Shoe (100) having at least one pressure sensor (110) provided in the shoe cushioning element (190), as well as system components for emitting, receiving and evaluating the signals of the sensor.

2. Shoe (100) according to claim 1, wherein the signals are received by an evaluation unit (200) and used for determining cushioning properties or the suitability of the shoe (100) for the ground on the evaluation unit (200) and showing the result on a display of the evaluation unit (200) or indicating it by one or several light-emitting diodes (120) provided in the shoe (100).

3. Shoe (100) according to claim 1, wherein the signals are received by an evaluation unit (200) and used for showing the pressure, the weight of the shoe user or a change of weight of the shoe user on a display of the evaluation unit (200).

4. Shoe (100) according to claim 1, wherein the signals are received by an evaluation unit (200) and used for showing the pressure frequency or a speed calculated from it on a display of the evaluation unit (200).

5. Shoe (100) according to claim 1, which is in addition equipped with a three-dimensional acceleration sensor (160), the signals of the pressure sensor (110) and the acceleration sensor (160) being sent to the evaluation unit (200) and used by the evaluation unit for determining the three-dimensional track, speed, power or energy of the movement and showing at least one of the determined results on a display of the evaluation unit (200).

6. Shoe (100) according to claim 1, which is in addition equipped with one or several light-emitting diodes (120b), LEDs, which are controlled by the signals of the pressure sensor (110), whereby these are activated by a control unit (130) when the ground is touched, so that the area in front of the shoe user is illuminated.

7. Shoe (100) according to claim 1, which is in addition equipped with a sensor for determining the orientation of several light-emitting diodes (120b), LEDs, provided in the shoe, and the data of said sensor are used by a control unit (130) for either activating just those light-emitting diodes (120b) oriented in various directions whose beam direction is oriented in the direction of the area in front of the shoe user, or for stabilizing the orientation of one or several light-emitting diodes (120b), so that the area in front of the shoe user is continuously illuminated.

8. Shoe (100) according to claim 1, which is in addition equipped with a rope winch (500) and an electric motor, the electric motor being activated by a control unit (130) according to the signal of the pressure sensor, and the rope winch (500) being rotated such that the shoelaces of the shoe (100) are tightened.

9. Shoe (100) according to claim 8, wherein the rope winch (500) is locked by a locking lever (520), and the locking lever is released by pressing a button (530) attached at the shoe (100).

10. Shoe (100) according to claim 1, wherein in addition an area of the shoe upper is provided with an insert, the insert being filled with an electro- or magneto-rheological fluid which is controlled by a control unit (130) according to the signals of the pressure sensor (110) such that, if no contact with the ground is detected, the highest viscousness of the electro- or magneto-rheological fluid is achieved.

11. Shoe (100) according to claim 1, wherein the shoe is equipped with several rigid cleats and several cleats movably held by means of a nut joint, and the movable cleats are oriented in the direction of inclination of the shoe by electromagnets attached around the cleats.

12. Shoe storage place (300), consisting of a housing (310) and an induction mat (320) located therein.

13. Method of controlling a system component by means of the signals of a piezoelectric pressure sensor (110) provided in a shoe cushioning element (190), comprising the procedure steps of
converting the pressure acting on the pressure sensor into electrical signals; and
emitting the electrical signals (130) to a control unit (130) or an evaluation unit (200); and
controlling at least one system component according to the received signals.

14. Method according to claim 13, wherein controlling consists in determining cushioning properties or the suitability of the shoe (100) for the ground and showing the result on a display of the evaluation unit (200) or showing it by activating at least one light-emitting diode (120), LED, provided in the shoe (100).

15. Method according to claim 13, wherein controlling consists in showing the pressure, the weight of the shoe user, or the change of weight of the shoe user on a display of the evaluation unit (200).

16. Method according to claim 13, wherein controlling consists in showing the frequency of the pressure signals of the pressure sensor or a speed calculated therefrom on a display of the evaluation unit (200).

17. Method according to claim 13, wherein the shoe (100) is in addition equipped with a three-dimensional acceleration sensor (160), and the further procedure step of
emitting the signals of the acceleration sensor (160) to the evaluation unit (200);
and furthermore controlling the evaluation unit consists in determining the three-dimensional track, speed, power or energy of the movement and showing at least one of the determined results on a display of the evaluation unit (200).

18. Method according to claim 13, wherein the control unit (130) controls several light-emitting diodes (120b), LEDs provided in the shoe (100), and controlling the LEDs consists in activating the LEDs with current when a pressure threshold value is exceeded.

19. Method according to claim 13, wherein the shoe (100) is equipped with a sensor for determining the orientation of several light-emitting diodes (120b), LEDs, provided in the shoe, and controlling the LEDs consists in activating either those light-emitting diodes (120b) oriented in various directions whose beam direction is oriented to the area in front of the shoe user, or stabilizing the orientation of one or several light-emitting diodes (120b) to said area.

20. Method according to claim 13, wherein the shoe (100) is equipped with a rope winch (500) and an electric motor, and controlling consists in activating the electric motor according to a pressure signal of the pressure sensor, so that the latter rotates the rope winch (500) such that the shoelaces of the shoe (100) are tightened.

21. Method according to claim 20, with the further procedure step of
arresting the rope winch (500) by a locking lever (520); and
releasing the locking lever (520) by pressing a button (530) attached at the shoe (100).

22. Method according to claim 13, wherein an area of the shoe upper is provided with an insert, and the insert is filled with an electro- or magneto-rheological fluid, and controlling consists in having an influence on the viscousness of the electro- or magneto-rheological fluid such that the highest viscousness of the electro- or magneto-rheological fluid is achieved when according to the signals of the pressure sensor (110), no contact with the ground is detected.

23. Method according to claim 13, wherein the shoe (100) is equipped with several rigid cleats and several cleats movably held by a nut joint, and controlling consists in orienting the movable cleats in the direction of inclination of the shoe by means of controllable electromagnets provided around each movable cleat.

24. Shoe (100) with a three-dimensional acceleration sensor (160), wherein of the is acceleration sensor (160) are sent to the evaluation unit (200) and used by the evaluation unit for determining the three-dimensional track, speed, power or energy of the movement and for showing at least one of the determined results on a display of the evaluation unit (200).

25. Shoe (100) with several light-emitting diodes (120b), LEDs, provided in the shoe, and a sensor for determining the orientation of the shoe, wherein the data of said sensor are used by a control unit (130) for either activating just those light-emitting diodes (120b) oriented in various directions whose beam direction is oriented in the direction of the area in front of the shoe user, or for stabilizing the orientation of one or several light-emitting diodes (120b), so that the area in front of the shoe user is continuously illuminated.

26. Shoe (100) with a rope winch (130) and an electric motor, the electric motor being activated by a control unit (130) according to the signal of a pushbutton, and the rope winch (100) being rotated such that the shoelaces of the shoe (100) are tightened.

27. Shoe with several plastic rods (410) between two shoe uppers (420, 430), wherein the plastic rods are connected with the shoe upper (420) on the one side lying very closely to each other, and are on the other side very loosely connected to the shoe upper (430), whereby bending is possible only in one direction.
